(19) United States
(12) Patent Application Publication
(10) Pub. No.: US 2013/0298542 A1
(43) Pub. Date: Nov. 14, 2013

(54) HYDRAULIC SYSTEM WITH RETURN PRESSURE CONTROL

(71) Applicants: Roger Lowman, Simpsonville, SC (US); Germano Franzoni, Prairie View, IL (US); Jarmo A. Harsia, Palatine, IL (US)

(72) Inventors: Roger Lowman, Simpsonville, SC (US); Germano Franzoni, Prairie View, IL (US); Jarmo A. Harsia, Palatine, IL (US)

(73) Assignee: PARKER-HANNINFIN CORPORATION, Cleveland, OH (US)

(21) Appl. No.: 13/994,927

(22) PCT Filed: Mar. 21, 2011
(86) PCT No.: PCT/US11/29152

§ 371 Date: Jul. 31, 2013

Related U.S. Application Data
(60) Provisional application No. 61/424,147, filed on Dec. 17, 2010.

(51) Int. Cl. F15B 15/18

(52) U.S. Cl. CPC F15B 15/18
USPC 60/327; 137/511; 137/565.16; 60/468; 251/129.07

(57) ABSTRACT

A hydraulic system (10) includes an electronically-controlled counter-pressure valve (60) that enables backpressure in a return line (36) of the system to be varied by a control unit (64). The system allows active control of the pressure in the return line to produce different return pressures for different situations. A higher return line pressure may be set to improve make-up or recirculating flow through an anti-cavitation valve (50). This may improve controllability of functions that benefit from backpressure, such as lowering loads (12). The control unit that controls the counter-pressure valve may take into account any of a wide variety of possible inputs when setting the counter-pressure valve.

### FIELD OF THE INVENTION

The invention is in the general field of hydraulic systems.

### DESCRIPTION OF THE RELATED ART

Hydraulic systems are used for a wide variety of purposes. Given the ubiquity and various uses of hydraulic systems, improvements in efficiency and/or performance of hydraulic systems would be desirable.

Prior hydraulic systems have utilized no backpressure control, or backpressure control in the form of a fixed counter-pressure valve or a hydraulically-controlled counter-pressure valve. Such systems provide at most crude passive backpressure control.

### SUMMARY OF THE INVENTION

According to an aspect of the invention, a hydraulic system includes an actively-controlled counter-pressure control valve.

According to another aspect of the invention, a hydraulic system includes an electronically-controlled counter-pressure control valve.

According to yet another aspect of the invention, a hydraulic system includes: a control valve for selectively controlling flow to and from a hydraulic load; a supply line coupled to the control valve for providing pressurized fluid to the control valve; a return line coupled to the control valve for directing return fluid away from the control valve; an electrically-controlled counter-pressure valve that maintains backpressure in the return line; and a control unit that is operably coupled to the electrically-controlled counter-pressure valve to selectively set the backpressure in the return line.

According to still another aspect of the invention, a method of operating a hydraulic system includes: actively controlling backpressure in a return line of the hydraulic system, wherein the actively controlling includes: receiving one or more inputs at an electronic control unit of the system; and the electronic control unit setting the pressure setting of a counter-pressure valve of the system that is in the return line, as a function of the one or more inputs.

According to a further aspect of the invention, a hydraulic system includes: a control valve for selectively controlling flow to and from a hydraulic load, wherein the control valve has a supply port that receives pressurized fluid, and wherein the control valve has a return port that directs fluid away from the control valve; an electrically-controlled counter-pressure valve that maintains backpressure at the return port; and a control unit that is operably coupled to the electrically-controlled counter-pressure valve to selectively set the backpressure at the return port.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The appended drawings show various features of embodiments of the invention.

FIG. 1 is a schematic diagram of a hydraulic system according to an embodiment of the invention.

FIG. 2 illustrates the hydraulic system of FIG. 1 in a first operation, an operation that involves high backpressure.

FIG. 3 illustrates the hydraulic system of FIG. 1 in a second operation, an operation that involves low backpressure.

FIG. 4 is a schematic diagram of a hydraulic system according to a first alternate embodiment of the invention.

FIG. 5 is a schematic diagram of a hydraulic system according to a second alternate embodiment of the invention.

FIG. 6 is a schematic diagram of a hydraulic system according to a third alternate embodiment of the invention.

FIG. 7 is a schematic diagram of a hydraulic system according to a fourth alternate embodiment of the invention.

### DETAILED DESCRIPTION

A hydraulic system includes an electronically-controlled counter-pressure valve that enables backpressure in a return line of the system to be varied by a control unit. The system allows active control of the pressure in the return line to produce different return pressures for different situations. A higher return line pressure may be set to improve make-up or recirculating flow through an anti-cavitation valve. This may improve controllability of functions that benefit from backpressure, such as lowering loads. The return pressure may be kept high in such situations in order to reduce pumping requirements and thereby improve productivity and/or reduce cavitation. In other situations the return pressure may be lowered in order to improve efficiency. The control unit that controls the counter-pressure valve may take into account any of a wide variety of possible inputs when setting the counter-pressure valve. The setting for the counter-pressure valve (the pressure in the return line upstream of the counter-pressure valve) may be a function of one or more of prime mover speed, pump flow, functional commands to hydraulic loads (such as actuators), functional load conditions, functional positions of the hydraulic loads, flow rates to and from the hydraulic loads, flow in the return line, and return line pressure.

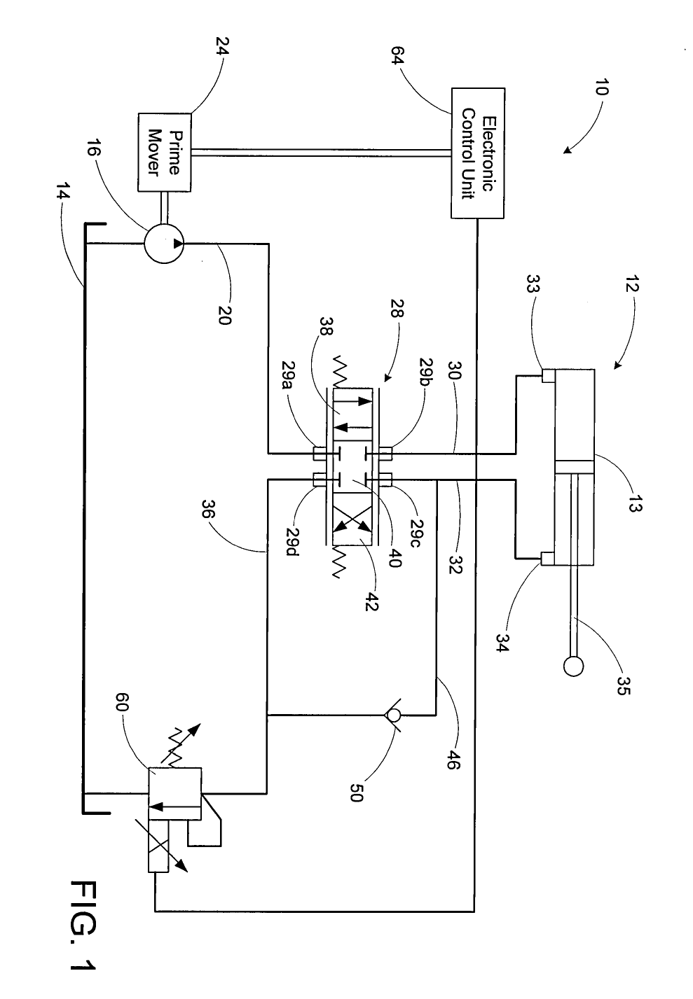

FIG. 1 shows a hydraulic system 10 for providing hydraulic fluid to a hydraulic load 12. In the illustrated embodiment the hydraulic load 12 is an actuator 13, such as a linear actuator or a rotary actuator. An example is an actuator for raising a load, such as in construction machinery. Another possible hydraulic load is a motor. Hydraulic fluid, such as a suitable hydraulic oil, is provided from a reservoir 14. A pump 16 draws the hydraulic fluid from the reservoir 14 through a supply line 20. The pump 16 may be variable or fixed displacement, and may be hydraulically or electrically controlled. The pump 16 is driven by a prime mover 24. The prime mover 24 is any suitable sort of machine that transforms energy from thermal, electrical, or pressure form, to mechanical form. Examples of suitable prime movers are motors and engines.

The supply line 20 is connected to a control valve 28 at a supply port 29a, which controls fluid flow to and from the hydraulic load 12. A pair of load feed lines 30 and 32 connect feed ports 29b and 29c of the control valve 28 to the hydraulic load 12. In the illustrated embodiment the feed lines 30 and 32 are connected to respective ports 33 and 34 of the actuator 13. When a piston 35 of the actuator 13 is extended, there is flow into the port 33 and out of the port 34. When the actuator piston 35 is retracted, there is flow into the port 34 and out of the port 33.

A return line 36 is coupled to a return port 29d of the control valve 28 to allow flow of hydraulic fluid back to the reservoir 14. The control valve 28 may be any of a variety of control valves for controlling flow to and from various parts of the hydraulic load 12. In the illustrated embodiment the control valve 28 is a three-position proportional control valve, but the control valve alternatively may be other types of control valves. In a first position 38 the supply line 20 is connected to the feed line 30, and the return line 36 is connected to the other feed line 32. In a second position 40 there is no connection between the supply and return lines 20 and 36, and the feed lines 30 and 32. In a third position 42 the connections are the reverse of those in the first condition, with the supply line 20 connected to the feed line 32, and the return line connected to the feed line 30.

A regeneration line 46 is provided, connecting the return line 36 to the feed line 32. An anti-cavitation check valve 50 that is located in the regeneration line 46 allows flow in only one direction, from the return line 36 to the feed line 32. One purpose of the line 46 is to prevent cavitation in the feed line 32, and/or in a portion of the hydraulic load 12 that is coupled to the feed line 32—when the pressure in the feed line 32 drops below that in the return line 36, the anti-cavitation check valve 50 opens, allowing flow into the feed line 32, and preventing cavitation.

A counter-pressure valve 60 is located in the return line 36, downstream of where the regeneration line 46 links into the return line 36. The counter-pressure valve 60 is an electronically-controlled valve that limits flow to the reservoir 14, so as to maintain a desired pressure in the portion of the return line 36 that is upstream of the counter-pressure valve 60. The counter-pressure valve 60 is set so as to allow flow back to the reservoir 16 only when the upstream pressure (or the pressure differential across the valve 60) exceeds a pressure setting or set value. The pressure setting of the counter-pressure valve can be varied by a control unit 64 that is operatively coupled to the counter-pressure valve 60. This allows the pressure in the upstream portion of the return line 36 be varied for different operating conditions.

The counter-pressure valve 60 may be electrically proportionally actuated by the control unit 64. The valve 60 can be either direct acting (proportional solenoid pushing against a spool) or pilot operated (proportional solenoid generating a variable pressure that pushes against a spool). The pressure setting of the return line 36 is thus actively controlled by the control unit 64.

The control unit 64 sets the pressure setting of the counter-pressure valve 60 as a function of any of, or any combination of, various inputs. Examples of the inputs that the control unit 64 may utilize include speed of primer mover 24 (e.g., engine or motor revolutions per minute (rpms)), flow rate of the pump 16, functional commands to the hydraulic load 12 (e.g., commands to raise or lower a load, possible include the rate of the raising or lowering), functional load condition of the hydraulic load 12 (the amount of loading experienced by the hydraulic load 12), functional position of the hydraulic load 12 (e.g., position of an actuator), flow rates to and from the hydraulic load 12 through the feed lines 30 and 32, flow in the return line 36, and return line pressure. The setting of the control valve 28 may constitute another example input. The examples above are not intended to be an exhaustive list—other inputs are possible.

The control unit 64 may be any of a variety of units that include computers, central processing units, integrated circuits, memory devices (ROM and/or RAM, or the like), for carrying out logical functions for controlling the counter-pressure valve 60 as a function of various inputs. The functions of the control unit 64 may be carried out in hardware or software.

The control unit 64 may be configured to maintain a high backpressure (high pressure in the return line 36 upstream of the counter-pressure valve 60) in situations when the high backpressure will improve performance of the system 10. The backpressure may be lowered in other situations, since maintaining a high backpressure in other situations would result in higher losses, which would negatively affect overall efficiency.

The control unit 64 may have other functions in addition to controlling the counter-pressure valve 60. For example the control unit 64 may control operation of the control valve 28, the pump 14, and/or the prime mover 24.

In the foregoing discussion flow is referred to as flowing through the supply line 20, the return line 36, the flow lines 30 and 32, and regeneration line 46. Such flow may also be referred to flow in the supply port 29a, flow out of the return port 29d, flow into and/or out of the feed ports 29b and 29c, and flow in communication with the feed port 29c and the supply port 29d, respectively.

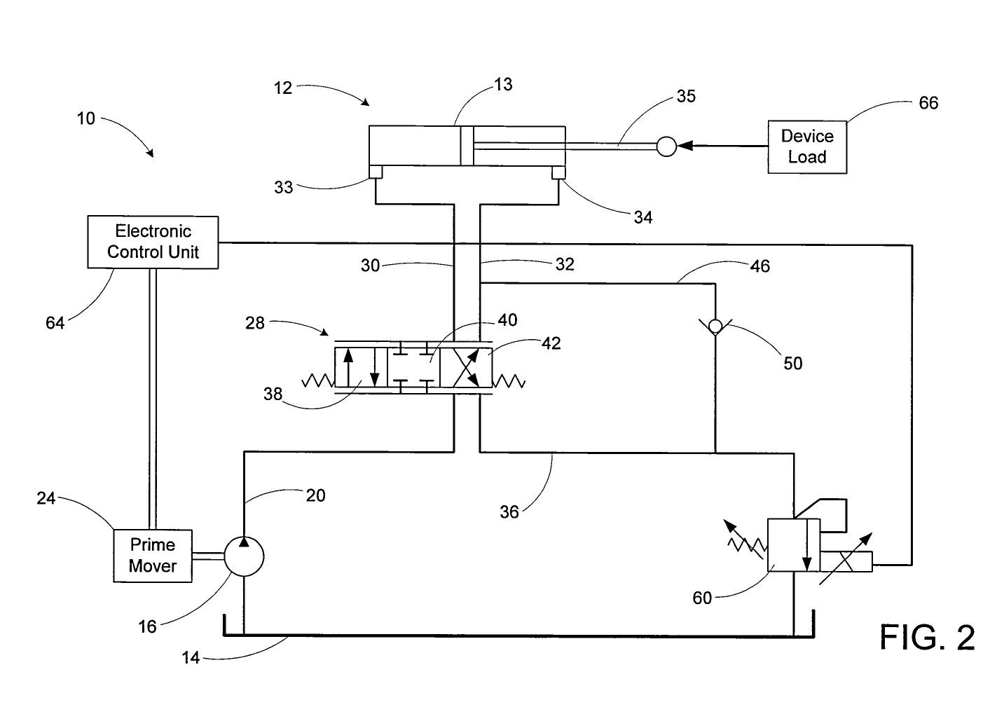

FIG. 2 illustrates operation of the system 10 in one situation where a high backpressure is beneficial, an operation of unloaded lowering of a device (not shown) that is coupled to the actuator 13. The device provides a device load 66 that presses against the piston 35, tending to retract the piston 35. An example of such a situation is the lowering of an unloaded bucket of a backhoe, with the weight of the bucket corresponding to the device load 66. In such a situation the backpressure advantageously provides a regenerating or recirculating flow, diverting some of the return flow back to the actuator 13. In the illustrated operation the control valve 28 is in the third position 42, with the supply line 20 in fluid communication with the feed line 32, and the return line 36 in fluid communication with the feed line 30. This enables the piston 35 to retract, with flow out of the actuator port 33, and flow into the actuator port 34. The load 66 is thus in the same direction as movement of the piston 35. The flow out of the actuator port 33 passes into the flow line 30, and through the control valve 28 to the return line 36.

The retraction of the piston 35 reduces the pressure in the flow line 32, which is coupled to the actuator port 34. Hydraulic fluid needs to be added through the port 34 to keep the actuator filled 13. If the backpressure in the return line 36 was to be kept low, substantially all of this fluid would have to come from the supply line 20, being pumped by the pump 14. However in the illustrated embodiment the backpressure in the return line 36 kept high, by the control unit 64 providing an appropriate pressure setting to the counter-pressure valve 60. This means that as the pressure goes down in the flow line 32, the pressure in the flow line 32 drops below that in the return line 36. The pressure differential causes the check valve 50 to open, with some of the flow into the return line 36 (from the port 33) being diverted into the regeneration line 46. Some of the flow leaving one side of the actuator 13 therefore is recirculated to the opposite side of the actuator 13. This recirculation of fluid reduces the amount of pumped fluid needed in the piston retraction operation.

The control unit 64 may use any of a variety of inputs to identify the operation illustrated in FIG. 2, so as to trigger increasing the pressure setting of the counter-pressure valve 60 so as to provide high backpressure. The positioning of the control valve 28 in the third position 42 may be used as an input that triggers the high backpressure. Alternatively the selection by an operator of a certain operation may be used as the input that triggers the high backpressure. Other inputs to produce the high backpressure are possible.

Improved performance that is obtained by increased backpressure in the operation illustrated in FIG. 2 and described above. The pump flow for a system without increased backpressure may be much higher than the pump flow for the system 10 with its active backpressure control.

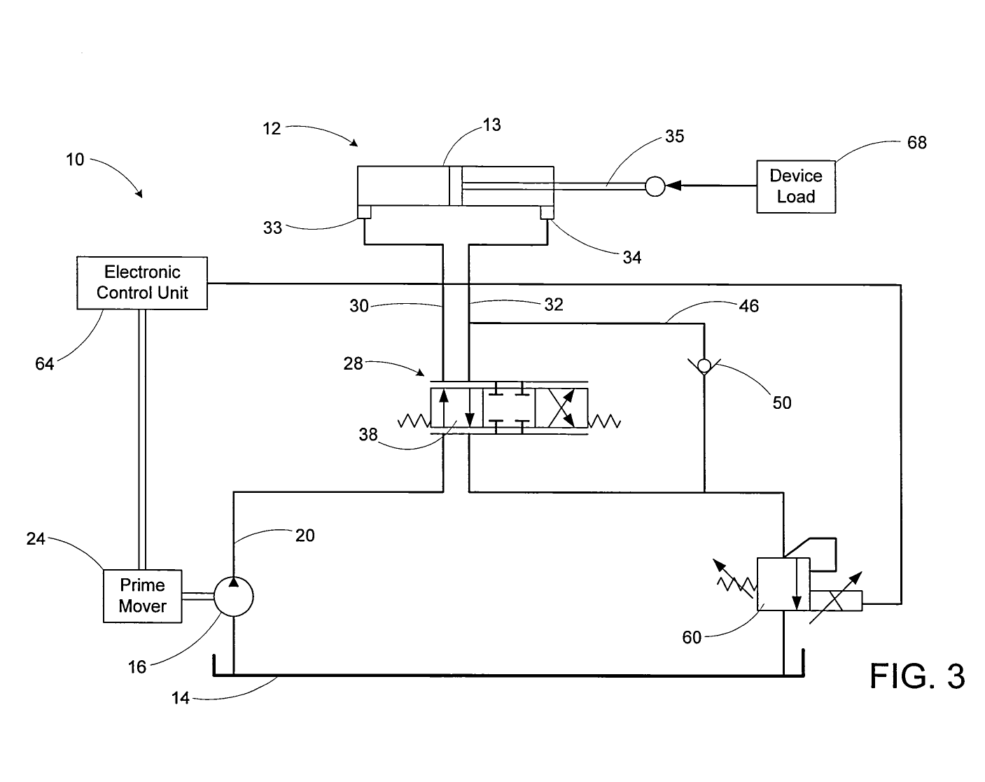

FIG. 3 illustrates another operation of the system 10, an operation extending the piston 35. The extension is accomplished against a device load 68, e.g., representing a mass that is raised by the system 10, which opposes movement of the piston 35. The control valve 28 is in the first position 38, with the supply line 20 connected to the flow line 30, to supply hydraulic fluid to the actuator 13 at the actuator port 33. As the piston 35 extends, hydraulic fluid is forced from the actuator port 34, through the flow line 24 and the return line 36, past the counter-pressure valve 60, and back to the reservoir 16.

It is advantageous for the backpressure to be low during the piston-extending operation illustrated in FIG. 3. Having the counter-pressure valve 60 set as it was for the operation of FIG. 2 (a high backpressure), would produce a high pressure in the chamber of the actuator 13 that is accessed by the actuator port 34. Such a high pressure would oppose extension of the piston 35. A higher pressure in the other chamber of the actuator would be necessary to overcome the high backpressure, making for less efficient operation. Therefore it is desirable for this operation for the backpressure to be low. Accordingly the control unit 64 sets the pressure setting of the control unit 60 at a low value, reducing the pressure in the chamber of the actuator 13 that is accessed by the actuator port 34.

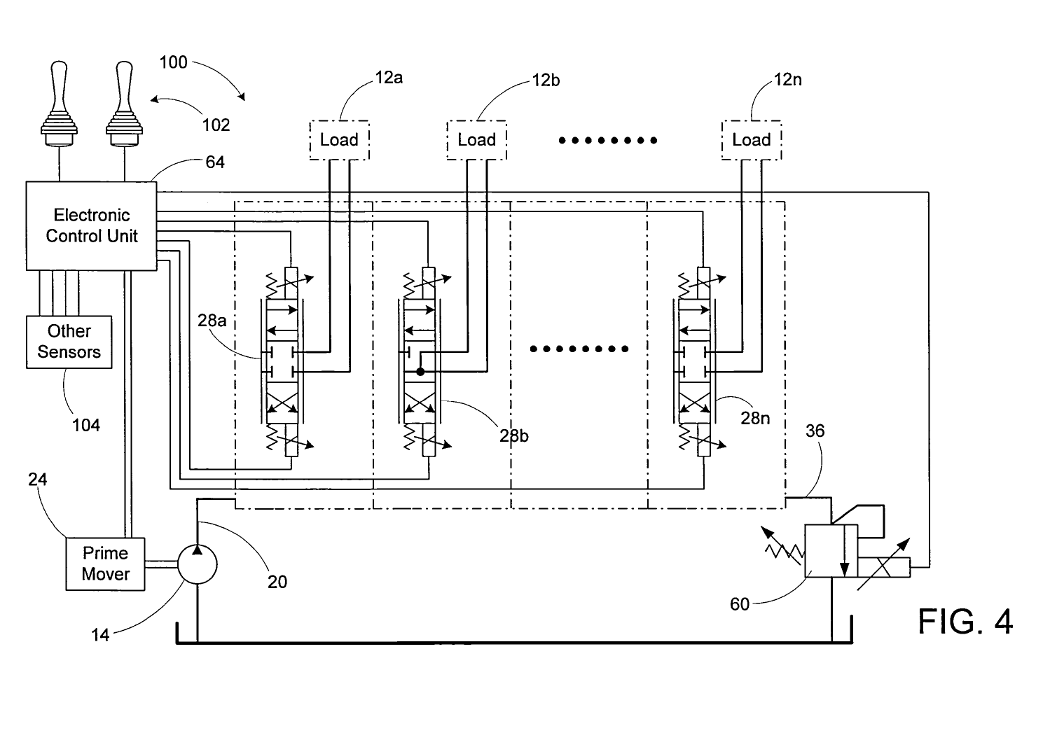

The two operations illustrated in FIGS. 2 and 4 illustrate an advantage of active control of the backpressure. It is desirable for there to be high backpressure for the operation of FIG. 2, yet low backpressure for the operation of FIG. 3. The use of the control unit 64 to control actively the setting of the counter-pressure valve 60 allows achieving different backpressures for different situations. The active control of the counter-pressure valve 60 may extend beyond a simple selection between a single high backpressure and a single low backpressure, based on a single type of operation. Instead it may extend to using multiple inputs to the control unit 64 to select any of a variety of possible desired backpressures.

FIG. 4 illustrates a hydraulic system 100 which is more complicated than the hydraulic system 10 (FIG. 1). Many parts of the hydraulic system 100 are similar to corresponding parts of the system 10. These similar features may be given the same or similar reference numbers, and mention of these similar features may be omitted in the description below.

The hydraulic system has multiple hydraulic loads 12a, 12b, . . . 12n, such as suitable actuators. Three hydraulic loads 12a, 12b, and 12n, are shown in FIG. 4, but any number of loads 12a-12n may be employed as part of the system 100. Flow to and from the hydraulic loads 12a-12n is controlled by control valves 28a, 28b, . . . 28n. There may be one control valve 28a-28n for each of the hydraulic loads 12a-12n, as in the illustrated embodiment, or alternatively some or all of the control valves may control flow to more than one hydraulic load. The control valves 28a, 28b, . . . 28n may function differently from one another. For example, in the illustrated embodiment the control valve 28b has a different configuration than the control valves 28a and 28n, with the control valve 28b having a neutral position that connects both ports of the corresponding hydraulic load 12b to the return line 36, while the corresponding position in the control valves 28a and 28n is a position that blocks flow to and from their corresponding hydraulic loads 12a and 12n.

As in the hydraulic system 10, an electronically-controlled counter-pressure valve 60, controlled by an electronic control unit 64, is used to set the backpressure in the portion of a return line 36 that is upstream of the counter-pressure valve 60. This portion of the return line 36 may be coupled, via regeneration lines (not shown), to flow lines between the control valves 28a-28n and the hydraulic loads 12a-12n.

The control unit 64 receives input from many possible sources, such as from the prime mover 24 that drives the pump 14, from operator controls 102 that are used by the operator of the system 100, and from sensors 104. The sensors 104 may be flow sensors, pressure sensors, position sensors, or other types of sensors, for sensing system characteristics at various locations in the system 100. For example the sensors 104 may be used to sense position of the hydraulic loads 12a-12n and/or the control valves 28a-28n. The electronic control unit 64 provides the counter-pressure valve 60 with a setting for the backpressure in the return line 36 that may be a function of multiple of the inputs to the control unit 64. For example some of the hydraulic loads 12a-12n may be actuators raising loads by extending pistons, while others may be undergoing unloaded lowering (pistons retracting). The control unit 64 may select an intermediate backpressure based on a compromise between operations that would benefit from a high backpressure and operations that would benefit from a lower backpressure. Other factors may be taken into account by the control unit 64. For example the setting that the control unit 64 provides to the counter-pressure valve 60 may be in part a function of the speed of the prime mover 24. If the prime mover 24 is at a low idle speed, less flow from the pump 14 may be available than if the prime mover 24 was operating at a high idle speed. The control unit 64 may be configured such that this low idle speed results in the pressure setting that is sent to the counter-pressure valve 60 being set higher than it would be set if the prime mover 24 was operating at a high idle speed.

The control unit 64 in the system 100 also controls other functions of the system 100. The control unit 64 also controls the operation of the control valves 28a-28n and the prime mover 24.

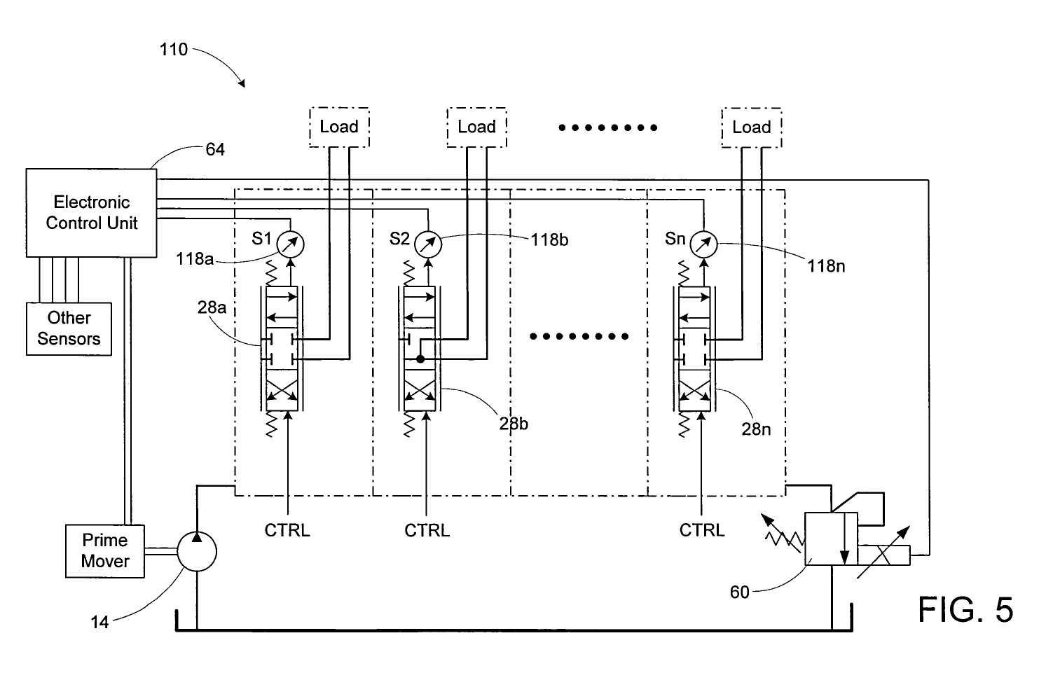

FIG. 5 shows an alternative embodiment hydraulic system 110. In the system 110 the spools of the control valves 28a-28n have a generic control, which may be manual control, hydraulic pilot control, on pneumatic control. Sensors 118a, 118b, . . . 118n read the positions of all or part of the spools, or a parameter(s) related the spool position(s). The sensors 118a-118n are coupled to the control unit 64, and provide input to the control unit 64 to aid determining the setting for the counter-pressure valve 60. In other regards the system 110 may be similar to the system 100 (FIG. 4).

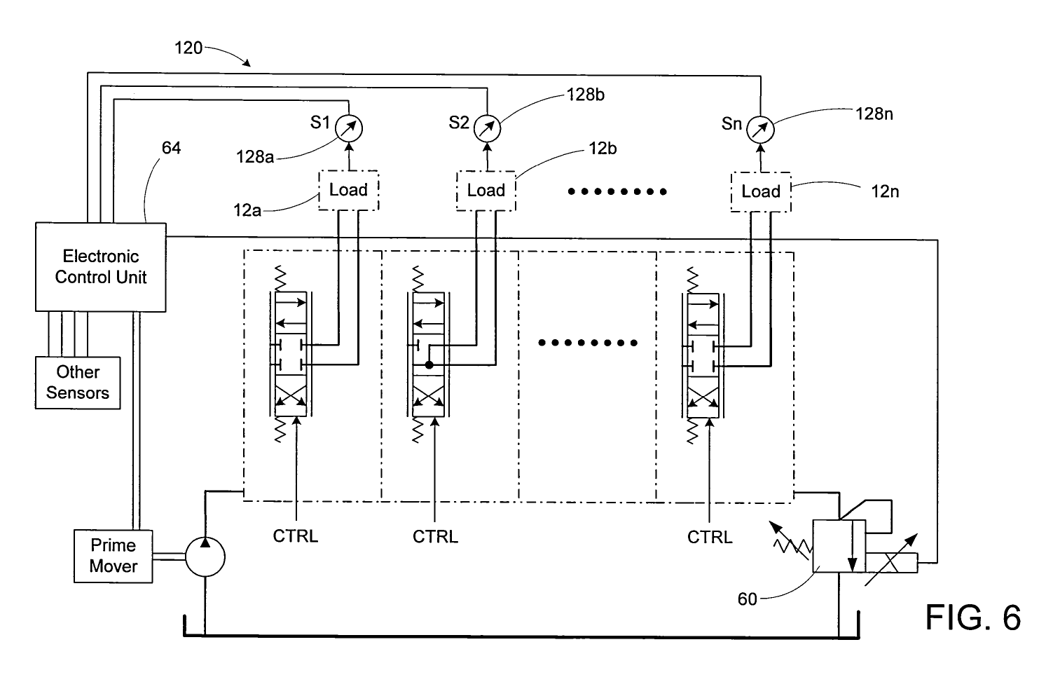

FIG. 6 shows another alternative embodiment, a hydraulic system 120 that has generic control of the spools of the control valves 28a-28n, as was described above with regard to the system 110 (FIG. 5). Sensors 128a, 128b, . . . 128n are coupled to the hydraulic loads 12a-12n. The sensors 128a-128n read the position, velocity, or other parameter related to operational characteristics of the hydraulic loads 128a-128n. The sensors 128a-128n are coupled to the control unit 64, and provide input to the control unit 64 to aid determining the setting for the counter-pressure valve 60. In other regards the system 120 may be similar to the system 100 (FIG. 4) and the system 110 (FIG. 5).

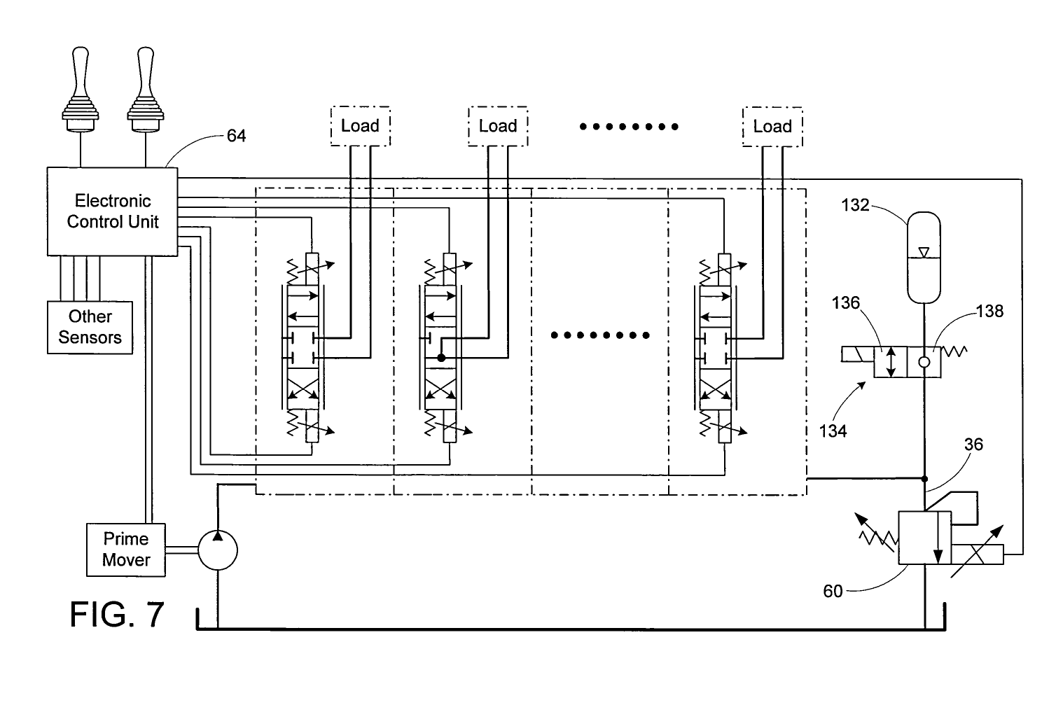

FIG. 7 shows still another embodiment, a hydraulic system 130 that includes an accumulator 132 that is coupled to the return line 36, upstream of the electronically-controlled counter-pressure valve 60. The accumulator 132 provides an additional way of controlling the pressure and flow through the return line 36 (and regeneration lines connected to the return line 36). The connection of the accumulator 132 to the return line 36 may be controlled by an accumulator control valve 134. The accumulator control valve 134 may be a two-position valve. In a first position 136 the accumulator control valve 134 may allow flow freely between the accumulator 132 and the return line 36. In a second position 138 the accumulator control valve 134 may function as a check valve, allowing flow only into the accumulator 132 from the return line 36, and not in the opposite direction. The second position 138 may be used to store fluid in the accumulator 132 when there is high backpressure and high return flow. The first position 136 may be used the backpressure in case the return flow is not very high (e.g., engine at low idle). The accumulator control valve 134 may be controlled using the electronic control unit 64. Alternatively the accumulator control valve 134 may be controlled in another way, such as by being manually controlled by an operator.

One or more sensors (not shown) may be coupled to the accumulator 132, the accumulator control valve 134, and/or the line linking the accumulator 132 to the return line 36. The sensor(s) may be coupled to the control unit 64 to provide input to the control unit 64 on data such as the accumulator pressure, flow rate into or out of the accumulator 132, and/or the position of the accumulator control valve 134. The control unit 64 may utilize these additional inputs in determining a setting for the counter-pressure valve 60.

The systems described provide more versatility than prior systems that utilized no backpressure control, or only crude backpressure control in the form of a fixed counter-pressure valve or a hydraulically-controlled counter-pressure valve. A counter-pressure valve having fixed characteristics (spring and delta pressure vs. flow) provides only simple passive backpressure control, as the valve characteristics are fixed and cannot be controlled by any external means. A hydraulically-controlled counter-pressure valve has its setting determined by a spring and an externally supplied pressure that comes from one or more spool actuators. The hydraulic pressure in the return line then depends on the sum of the spring counter-pressure valve setting and the external pilot pressure, and on the valve characteristics (delta pressure vs. flow). The control of the return pressure (backpressure) is variable but it must follow the pilot pressure trend and it is not affected by other parameters. Again there is not the active control of the current electronically-controlled counter-pressure, in which pressure setting is actively controlled in a versatile fashion, enabling the pressure setting being a function of any of a wide variety of inputs.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hydraulic system comprising:
a control valve for selectively controlling flow to and from a hydraulic load, wherein the control valve has a supply port that receives pressurized fluid, and wherein the control valve has a return port that directs fluid away from the control valve;
an electrically-controlled counter-pressure valve that maintains backpressure at the return port; and
a control unit that is operably coupled to the electrically-controlled counter-pressure valve to selectively set the backpressure at the return port.

2. The hydraulic system of claim 1, wherein the return port is coupled, via a regeneration line, to a feed port of the control valve connects the control valve to the hydraulic load.

3. The hydraulic system of claim 2, wherein the regeneration line has an anti-cavitation check valve that allows flow only from the return port to the feed port.

4. The hydraulic system of any of claims 1 to 3,
further comprising:
a pump that supplies fluid to the supply port; and
a prime mover operatively coupled to the pump, to power the pump;
wherein the control unit is operably coupled to at least one of the pump or the prime mover; and
wherein the control unit selectively sets backpressure at the return port at least in part on information concerning the pump or the prime mover.

5. The hydraulic system of any of claims 1 to 4, wherein the control unit sets the backpressure at the return port based on one or more of a primer mover speed, a pump flow, a functional command to the hydraulic load, functional load condition regarding the hydraulic load, a functional position of the hydraulic load, a flow rate to the hydraulic load, a flow rate from the hydraulic load, a flow rate in a return line coupled to the return port, and a return line pressure in the return line.

6. The hydraulic system of any of claims 1 to 5, further comprising the hydraulic load.

7. The hydraulic system of claim 6, wherein the hydraulic load is an actuator.

8. The hydraulic system of claim 6 or claim 7,
further comprising:
an additional hydraulic load; and
an additional control valve for selectively controlling flow to and from the additional hydraulic load;
wherein the control unit selectively sets the backpressure in a return line coupled to the return port, at least in part on inputs received from both of the hydraulic loads or from both of the control valves.

9. The hydraulic system of any of claims 1 to 8,
further comprising one or more sensors operably coupled to the control unit;
wherein the control unit selectively sets the backpressure at the return port at least in part on information received from the one or more sensors.

10. The hydraulic system of claim 9, wherein the one or more sensors includes a sensor that provides an indication of position of the control valve.

11. The hydraulic system of claim 9, wherein the one or more sensors includes a sensor that provides an indication of position of the hydraulic load.

12. The hydraulic system of claim 9, wherein the one or more sensors includes a flow sensor.

13. The hydraulic system of claim 9, wherein the one or more sensors includes a pressure sensor.

14. The hydraulic system of any of claims 1 to 13, further comprising an accumulator coupled to a return line that is coupled to the return port.

15. The hydraulic system of claim 14, further comprising an accumulator control valve that controls flow between the accumulator and the return line.

16. The hydraulic system of claim 14 or claim 15, wherein the control unit selectively sets the backpressure in the return line at least in part on a pressure in the accumulator.

17. A method of operating a hydraulic system, the method comprising:
actively controlling backpressure in a return line of the hydraulic system, wherein the actively controlling includes:
receiving one or more inputs at an electronic control unit of the system; and
the electronic control unit setting the pressure setting of a counter-pressure valve of the system that is in the return line, as a function of the one or more inputs.

18. The method of claim 17, wherein one or more inputs includes one or more of a primer mover speed, a pump flow, a functional command to a hydraulic load of the system, a functional load condition regarding the hydraulic load, a functional position of the hydraulic load, a flow rate to the hydraulic load, a flow rate from the hydraulic load, a flow rate in a return line of the system, and a return line pressure in the return line.

19. The method of claim 17, wherein the actively controlling the backpressure includes raising the backpressure to recirculate hydraulic fluid from the return line to a flow line of the hydraulic system, wherein the flow line is between a control valve of the hydraulic system and a load of the hydraulic system.

20. The method of claim 19, wherein the raising the backpressure includes recirculating the hydraulic fluid through an anti-cavitation check valve in a regeneration line that connects the return line to the flow line.
